(19) United States
(12) Patent Application Publication
(10) Pub. No.: US 2017/0218207 A1
(43) Pub. Date: Aug. 3, 2017

(54) Iridescent Article

(71) Applicant: The Procter & Gamble Company, Cincinnati, OH (US)

(72) Inventors: Libin Wang, Beijing (CN); Ping Wang, Beijing (CN); Liang Wang, Beijing (CN); Zhe Guan, Beijing (CN); Yanlin Song, Beijing (CN); Fengyu Li, Beijing (CN)

(21) Appl. No.: 15/407,281

(22) Filed: Jan. 17, 2017

(30) Foreign Application Priority Data
Jan. 29, 2016 (WO) CN2016072710

(51) Int. Cl. C09D 5/29; C09D 133/12; C09D 5/33; C09D 5/22; C09D 7/12

(52) U.S. Cl. CPC C09D 5/29; C09D 5/22; C09D 7/1275; C09D 5/004; C09D 133/12

(57) ABSTRACT

A method of decorating an article having an iridescent visual effect and an article with surface decoration are provided. The method comprises depositing a plurality of mono-dispersed particles onto a curved surface of the article, each particle having a size of from about 230 nm to about 360 nm with a polydispersity index (PDI) of below 0.2, to form a layer of regularly-ordered colloidal crystals on a surface having a curvature of at least 0.02 cm⁻¹. The colloidal crystals create an iridescent visual effect on the surface where multiple colors can be seen as a person views the substrate from different angles, and the intensity and brightness of the colors is at an optimal level.

### TECHNICAL FIELD

The present invention relates to a method of depositing mono-dispersed particles onto a curved surface to form ordered colloidal crystal structures that provide an iridescent effect, and to an article having a curved surface on which ordered colloidal crystal structures are formed to provide an iridescent effect.

### BACKGROUND

Visual effects on packaging connote different levels of quality to consumers buying products contained in the packaging. Furthermore, different visual effects can draw attention to packaging so that consumers' eyes are drawn more easily to those products, for example, when placed on shelf in a busy supermarket. One particularly desirable visual effect is that of iridescent colors, where the pack may look different depending on the angle a consumer views it from. At present, vacuum metallization is used to create an iridescent effect on plastic packaging. This is done by coating several micrometer thin layers of different materials (one of which is metal) on top of each other on a substrate in a vacuum environment, at a certain temperature and pressure. The overlapping materials have different refractive indices and generate interference light at different times and of different wavelengths to present an angle-dependent color effect.

Use of such vacuum metallization poses some challenges. Packaging decorated in this way is typically not recyclable, and there may be toxicity problems associated with the metal materials deposited on the surface. Furthermore, vacuum metallization is time consuming since it adds another step to the manufacturing process, which is undesirable from an efficiency point of view. To date, however, an alternative solution for providing the same effect on 3D packaging has not been realized in a way that is more environmentally friendly and cost-efficient.

Alternative ways to generate an iridescent effect have been disclosed. For example, highly ordered colloidal crystal structures, which diffract individual light wavelengths within a narrow spectrum, are known to present arrays of colors with high purity and intensity.

For example, BASF Polymer Bulletin 2006, volume 57, page 785-796 describes use of colloidal crystals on flat paper or glass to produce the spectrum of different visible colors when the film is viewed from different angles. The attributes of colors produced on an aluminium substrate using the method described in this BASF paper is shown herein as FIG. 2A. From this it can be seen that the colloidal crystals deliver intense colors (discussed further herein), together with a wide range of colors dependent on particle size (from violet, blue, green and orange to red—corresponding to core-shell particle diameters of 226 nm, 241 nm, 281 nm, 295 nm and 321 nm).

When the substrate is bent, however, the resultant curved surface does not exhibit the full range of visible colors, and the reflectance of the colors is relatively low, thus diminishing the desired “shining” effect (BASF method reproduced on an aluminium substrate and shown in FIG. 1B herein). Thus, it is evident that while, generally, use of colloidal crystals provides a better visual effect than vacuum metallization, this is only true on flat surfaces. Thus, there is clearly a need to provide an enhanced method of generating a visual effect on 3D packaging, which provides for the full range of iridescent colors with high clarity and high brightness.

### SUMMARY

According to the present invention, there is provided a method of depositing mono-dispersed particles having a particle size of 150 nm to 360 nm on a curved substrate selected from one of a group consisting of glass, metal (e.g., aluminium or steel), ceramic, polymer (e.g., polyethylene, polypropylene, PET), paper, fiber, wood and bamboo.

Deposition of the mono-dispersed particles on a curved substrate creates regularly ordered colloidal crystals directly onto the surface of the article. The colloidal crystals create an iridescent visual effect on the surface where multiple colors can be seen as a person views the substrate from different angles, and the intensity and brightness of the colors is at an optimal level.

### BRIEF DESCRIPTION OF THE DRAWINGS

While the specification concludes with claims, it is believed that the same will be better understood from the following description taken in conjunction with the accompanying drawings in which:

FIGS. 1A and 1B are graphs showing the different characteristics of color generated by colloidal crystals according to different methods described in the prior art;

FIG. 2 is a graph showing the different characteristics of iridescent colors generated by colloidal crystals of the present invention;

FIGS. 3A, 3B, 3C and 3D are graphs showing the different characteristics of iridescent colors generated by colloidal crystals of the present invention.

### DETAILED DESCRIPTION

In the present invention, it has surprisingly been found that depositing mono-dispersed particles directly onto a curved substrate to form colloidal crystals will create an iridescent visual effect on the substrate surface where multiple pre-determined colors can be seen as a person views the substrate from different angles, and the intensity and brightness of the colors meets a certain pre-requisite standard previously not achievable with colloidal crystals. Without being bound by theory, it is thought that the visual effect obtained when using mono-dispersed particles is a result of:

1. The assembly order situation of all particles; and

2. Defect cracks in the sample.

If mono-dispersed particles are applied to a flat surface that is subsequently bent into shape, a mechanical force is transferred from the substrate to the colloidal crystals formed on the substrate. The assembly situation of the colloidal crystals will change and defect cracks may appear which deteriorate the overall appearance. This causes a reduction in reflectance of the colloidal crystals. By contrast, when applying mono-dispersed particles directly to a curved surface, the assembly situation of the particles remains the same (as there is no subsequent reformation of the substrate surface) and, since the particle size of the mono-dispersed polymer particles is much less than that of the radius of curvature, the intensity of the mono-dispersed polymer particles as seen by a user is approximately the same as if the particles had been applied to a flat surface. Furthermore, the radius of curvature of the substrate means that the viewing angle of the colloidal crystals varies more readily than when viewing a flat surface, such that a consumer looking at the substrate will appreciate a greater range of different colors over a smaller surface area (compared with a flat surface).

All percentages are weight percentages based on the weight of the composition, unless otherwise specified. All ratios are weight ratios, unless specifically stated otherwise. All numeric ranges are inclusive of narrower ranges; delineated upper and lower range limits are interchangeable to create further ranges not explicitly delineated. The number of significant digits conveys neither limitation on the indicated amounts nor on the accuracy of the measurements. All measurements are understood to be made at about 25° C. and at ambient conditions, where “ambient conditions” means conditions under about one atmosphere of pressure and at about 50% relative humidity.

“Colloidal crystals”, as used herein refers to a coating layer generated by the periodic assembly of mono-dispersed particles, demonstrating a visible color attributable to light diffraction caused by its periodic structure. The term “mono-dispersed particles” herein refers to particles of a relatively uniform size, which form a periodic structure that selectively diffracts visible light of certain wavelengths and that therefore renders the colloidal crystals a visible color corresponding to the diffracted wavelengths. The mono-dispersed particles, as used herein, are made of polymers (e.g., polystyrene, polyacrylic acid) or inorganic materials (e.g., silica, titanium dioxide). In the colloidal crystal structure, the mono-dispersed particles are closely-packed and regularly-ordered, i.e., the particles are arranged in contact with one another to form the colloidal crystals.

“Polydispersity index (PDI)” as used herein is a parameter characterizing the distribution width of the particle sizes of the mono-dispersed particles. In the present invention, the PDI is tested according to method ISO 13321:1996E (1996) “Particle Size Analysis—Photon Correlation Spectroscopy”. As the value decreases, the particles have more narrowly distributed particle sizes.

“Iridescent color” is defined as the appearance of multiple colors dependent on the viewing angle or angle of illumination of particles providing the color. For example, a colloidal crystal having a single reflection peak wavelength may exhibit different colors depending on from where the crystal is seen. To be iridescent, two or more colors must be seen (when viewing the same particle/crystal). In some instances, this may be two or three neighboring colors of the rainbow (e.g., cyan, blue and purple), or it may include the entire rainbow of visible colors (e.g., red, orange, yellow, green, cyan, blue and purple). In the present invention, the iridescent color effect may be controlled by: i) adjusting the particle size of the mono-dispersed polymer particles therein; ii) adjusting the curvature of the substrate (or the length of the arc); iii) and/or selecting a particular type of deposition method (including, for example, changing the thickness of the deposited layer).

“Article”, as used herein refers to an individual object for consumer usage, eg., a shaver, a toothbrush, a battery, or a container suitable for containing compositions. Preferably the article is a container, non-limiting examples of which include a bottle, a tottle, a jar, a cup, a cap, and the like. The term “container” is used to broadly include elements of a container, such as a closure or dispenser of a container. The compositions contained in such a container may be any of a variety of compositions including, but not limited to, detergents (e.g., laundry detergent, fabric softener, dish care, skin and hair care), beverages, powders, paper (e.g. tissues, wipes), beauty care compositions (e.g., cosmetics, lotions), medicinal, oral care (e.g., tooth paste, mouth wash), and the like. The container may be used to store, transport, or dispense compositions contained therein. Non-limiting volumes containable within the container are from 5 ml, 10 ml, 100 ml, 500 ml or 1000 ml to 1500 ml, 2000 ml or 4000 ml.

### Colloidal Crystals

Colloidal crystals built up by mono-dispersed particles have been known to yield color effects as a result of the periodic arrangement of the mono-dispersed particles therein. Specifically, a plurality of mono-dispersed particles having a wavelength in the range of visible light is assembled in a closely-packed and regularly-ordered structure to form photonic crystals. This highly organized structure selectively diffracts certain wavelengths of light and therefore renders a color corresponding to the diffracted wavelengths. The color effects can be optimized by adjusting the refractive index in the structure, changing materials or particle sizes of the mono-dispersed particles, etc.

Of particular interest are colloidal crystals with relatively small refractive index differences that exhibit iridescent color, due to Bragg diffraction when the size of the colloid particles is comparable to the wavelength of the visible light.

Without being bound by theory, the choice of particle size dictates the range of wavelengths of visible light seen by human eyes when observing the substrate from different angles. This is in accordance with Bragg's law:

λ=2n_{eff}d sin θ

here θ is the angle of diffractive light, corresponding to the viewing angle of observer.

A person may view the substrate from a range of e between 0° and 90°. Applying Bragg's law, if it is desired that in a particular instance, the colloidal crystals on an article should enable a person passing by to see the full range of visible colors of the rainbow, then the reflection peak wavelength should fall within the wavelength of red light (620 nm to 780 nm). When looked at perpendicularly, the colloidal crystals would appear red. As the viewing angle decreases, applying Bragg's law, other colors from the visible rainbow become visible to the person. However, if the reflection peak wavelength is less than 620 nm, then red would be missing from the range of colors observed by a person (thus, they would not observe the full spectrum of the rainbow). Furthermore if the particle size is even smaller, (e.g., less than the wavelength of violet light—i.e., below 300 nm), then regardless of the viewing angle, no colors will be observed by a person looking at the colloidal crystals. The converse is true where the particle size is too big (e.g., more than the wavelength of red light—i.e., above 900 nm)—then the reflection peak wavelength would be beyond that of visible light from at least some angles, such that color would not be seen consistently.

In the present invention, the mono-dispersed particles have a size of between 150 nm and 360 nm and the subsequently formed colloidal crystals have a reflection peak wavelength of from 300 nm to 900 nm. Several preferred embodiments may exist dependent on the desired visual effect of a particular article. For example, where a rainbow effect is required, the particle size is preferably between 258 nm and 325 nm, and the reflection peak wavelength of the colloidal crystals falls within the red wavelength range (i.e., 620 nm to 780 nm) to ensure red is the main color of the iridescent effect. In a preferred embodiment, the mono-dispersed particles will have a particle size of approximately 272 nm to form colloidal crystals with a reflection peak wavelength of approximately 650 nm, which provides red of the highest reflection intensity and peak width (translating as highest purity and brightness).

In an alternative embodiment, the mono-dispersed particles preferably have a particle size of from 205 nm to 242 nm (preferably 233 nm), generating colloidal crystals with reflection peak wavelength of 505 nm to 575 nm (preferably 550 nm), providing iridescent color starting with green, and covering blue and violet when viewed from lesser angles. At a particle size of 233 nm, the brightest and most pure green can be seen.

In a further alternative embodiment, the mono-dispersed particles preferably have a particle size of from 178 nm to 200 nm (preferably 197 nm) and the subsequent colloidal crystals have a reflection peak wavelength of from 450 nm to 490 nm (preferably 475 nm), providing iridescent color starting at blue when viewed perpendicularly and covering violet (and other purple colors) when viewed from alternate angles.

In embodiments, the mono-dispersed polymer particles described herein have a PDI of below 0.2, preferably below 0.1, 0.05, 0.02 or 0.001. PDI is used to describe the size distribution of particles. The lower the PDI, the more ordered the resultant colloidal structure will be, diffracting light with a higher and narrower reflection spectrum, leading to a brighter iridescent effect and more purity of the individual colors. As the PDI is increased, the presence of larger particles will disrupt the order of the colloidal crystal reducing the overall intensity of color and causing blurs in distinction between different colors.

The thickness of the colloidal crystals has an impact on peak intensity and peak width, but not the reflection peak wavelength. However if, during application, the layer of colloidal crystals becomes too thick, defects may occur during assembly and the ordered structure may be compromised, thus lowering the peak intensity and providing large peak widths. The defects may also scatter light, resulting in a more whitish color. Thus, in a preferred embodiment, the thickness of the layer of colloidal crystals is between 1 μm and 1000 μm, preferably 5 μm to 20 μm. Below this level there are insufficient colloidal crystals to provide the iridescent effect, whereas above this level, the light reflected will be mainly white and the iridescent visual effect will be lost.

### Substrate

The substrate material may be any substrate typically used for packaging. For example, the substrate may be formed of glass, metal, ceramic, polymer, paper, fiber, wood, bamboo or a combination thereof. In an embodiment, the substrate is formed of glass selected from the group consisting of silicate glass, borate glass, phosphate glass and a combination thereof. Preferably the glass material is silicate glass or a derivative thereof, for example soda-lime silicate glass.

In an alternative embodiment, the substrate is formed of metal selected from the group consisting of aluminium, aluminium alloy, aluminium foil, stainless steel, low carbon steel, galvanized steel, tin plate, chrome plate and composites and derivates thereof. Preferably the substrate is formed of aluminium and/or derivatives thereof.

In a further embodiment, the substrate is formed of polymer selected from the group consisting of polyethylene (PE), polypropylene (PP), polyethylene terephthalate (PET), polyethylene therephthalate glycol (PETG), polystyrene (PS), polycarbonate (PC), polyvinyl chloride (PVC), polyvinyl dichloride (PVDC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBT), acrylonitrile styrene (AS), styrene butadiene copolymer (SBC) polyhydroxyalkanoates (PHA), polycaprolactone (PLC), polycyanoacrylate (PACA), polyhydroxybutyrate (PHB), copolymer of 1,3-propanediol and p-Phthalic acid, ethylene vinyl alcohol copolymer (EVOH), polymethyl methacrylate (PMMA), extrudable PET, ethylene (vinyl acetate (EV), ethylene/acrylic acid (EAA), ethylene/methyl acrylate (EMA), ethylene/ethyl acrylate (EEA), ethylene acrylic acid ionomers, cyclic olefin copolymers (COC), polyamides, thermal plastic elastomer (TPE), rubber and a combination thereof. Preferably, the substrate is formed of PET or derivatives thereof.

In an embodiment, the substrate is formed of paper selected from the group consisting of carton board, case board, corrugated paper and a processed paper thereof. Preferably, the substrate is formed of carton and/or a product processed thereof.

In another embodiment, the substrate is formed of fiber selected from the group consisting of natural silk, chemical fiber, cotton and a combination thereof.

The choice of substrate has an impact on the overall characteristics (e.g., purity and intensity of color). For example, if the same mono-dispersed particles are applied at the same thickness to a glass substrate and an aluminium substrate, the colors seen on the glass substrate will be more intense and purer relative to the aluminium substrate. This is because aluminium has a high reflection rate and white color, which decreases the contrast of the color effect between the colloidal crystals and substrate. Regardless of the substrate, however, the relative purity and intensity of the iridescent colors generated by colloidal crystals where the mono-dispersed particles are applied directly to a curved surface will be greater than if the mono-dispersed particles are applied to a flat surface that is subsequently bent.

### Curvature of the Article

Curvature, in the present invention, is the degree by which the substrate deviates from being flat. The value of curvature is calculated as the reciprocal of the radius of curvature. As the value increases, the substrate has a higher degree of curvature. In embodiments having a generally round cross section with diameter of from about 1 cm to about 30 cm, the curvature of the substrate is from about 0.067 cm⁻¹ to about 2 cm⁻¹. For an article having a substantially oval cross-section with a width of from about 1 cm to about 30 cm, the minimum curvature of the substrate is from about 0.002 cm⁻¹ to about 1.7 cm⁻¹. Any degree of curvature will provide the benefit of the present invention to some extent, provided the substrate is bent prior to application of the mono-dispersed polymer particles. It will be appreciated that the curvature of the substrate will eventually be governed by the intended application of the packaging. As an example, TABLE 1 below shows the dimensions of a variety of packaging currently on the market.

| | | Safeguard | Olay | Crest | Olay |
|---|---|---|---|---|---|
| | Tide HDL | hand wash | lotion | toothpaste | eye roller |
| | 225 oz | 1.5 L | 150 ml | 240 g | 6 ml |
| Package | Approximate | Approximate | Oval | Oval | Round |
| shape | oval | oval | | | |
| Curvature | ~0.048 | ~0.109 | 0.284 | 0.500 | 1.250 |
| (cm⁻¹) | | | | | |

In an embodiment, the article may be formed of multiple layers, in which case, the mono-dispersed particles should be applied to a layer visible from the exterior of the article. Typically, the mono-dispersed particles will be applied to the outermost layer, however, in embodiments, the outermost layer may be transparent or translucent, in which case the mono-dispersed particles may be applied to the layer beneath the transparent or translucent layer.

### Application of Mono-Dispersed Particles to a Substrate

In an embodiment, the mono-dispersed particles may be applied to the substrate by any known method, including vertical deposition, dip coating, spray painting, spin coating, blade coating, inkjet printing, water transfer printing, pad printing, silk screen printing and shear ordering method. In a preferred embodiment, the mono-dispersed particles are applied to the substrate using vertical deposition. The typical process of vertical deposition is as follows:
prepare an suspension of mono-dispersed particles with a concentration of from 0.1% to 1% by weight in a container
submerge the curve substrate vertically into the suspension without touching the inner wall of the container
put the container in a chamber with controlled temperature of from 20° C. to 80° C. and humidity of from 20% to 80%.

Using this method, the solvent evaporates at the air-liquid-solid interface, causing the mono-dispersed particles in the suspension to self-assemble at the air-liquid-solid interface, thus forming colloidal crystal structures on the substrate. The preferred concentration of particle suspension is 0.5% by weight. The preferred chamber temperature and humidity are 80° C. and 80% respectively.

### Methods

The iridescent visual effect of the present invention is demonstrated using the reflectance spectrum. The reflectance spectrum is a measure of the spectral properties of specular reflection light. Optical reflection measurement in different angles of incident light is carried out with an Ideaoptics (PG2000-Pro spectrometer equipped with a FIB-600-DUV optical fiber. A support named RI system (Ideaoptics Instrument Co., Ltd) with 360° rotating arms equipped with a light source (xenon lamp from iDH2000—Ideaoptics Instrument Co., Ltd) and a detector, and a horizontal sample stage in the centre is used herein to collect reflectance spectrums at incident angles of from 0° to 90°. The instrument is calibrated by a spectrum obtained by illustration on an STD-M standard reflector board. A bright field is calibrated as 100% reflection, while a spectrum obtained without light source is (i.e., a dark field), is calibrated as 0% reflection.

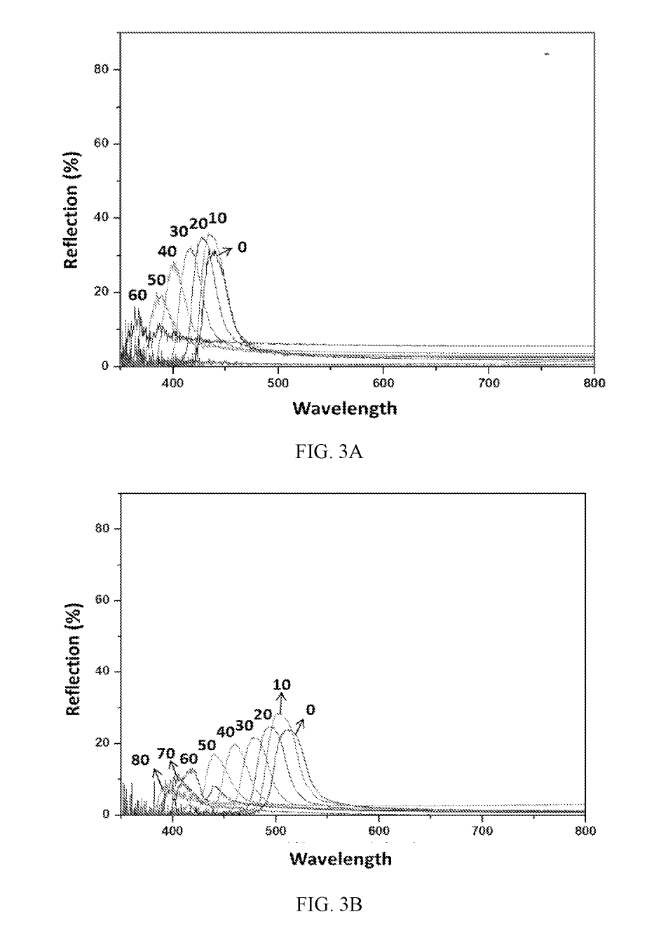

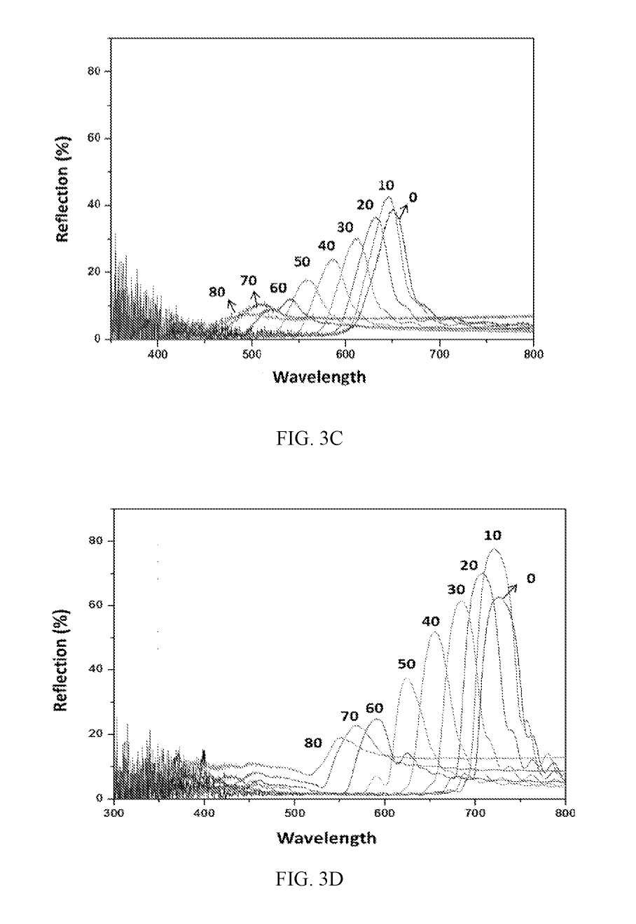

There are 3 key parameters indicated from the reflectance spectrum as shown in FIG. 3: reflection peak wavelength, intensity and peak width at half height. Reflection peak wavelength indicates the wavelength (nm) of reflected light (e.g., 650 nm for red, 550 nm for green etc), determining the color of the sample. Intensity is a relative value (%)—the higher the intensity the more a particular color shines. Peak width at half height indicates the color purity (e.g., the smaller the peak width, the purer the color) and finally, stopband shift is the difference between reflection peak wavelength positions (nm) at different viewing angles.

Reflection peak wavelength is influenced by the particle size and is independent of the substrate material. The preferred range of reflection peak wavelength is between 300 nm and 900 nm. If the wavelength is below 300 nm, no colors will be observed. If the wavelength is above 900 nm, then iridescent colors will not be observed.

The range of peak width is influenced by the assembly ordering of the colloidal crystals. In an embodiment, the range of peak width is from 10 nm to 200 nm. Above 200 nm, the color is blurred. Below 10 nm is a “perfect” scenario where the colloidal crystal structure would be formed without any defects, which is not practical in reality. The smaller the peak width, the purer that color will be. Conversely, as the peak width increases there is more chance of blurring between colors.

Reflection Intensity is a relative value influenced by the colloidal crystal ordering and thickness and the substrate material and test method. Using the test method described above, intensity can be compared for colloidal crystals located on a chosen substrate (e.g., aluminium). If the substrate is different (e.g., for colloidal crystals on aluminium vs glass), the intensities measured will not be absolute. In general, however, the higher the intensity of color, the brighter that color will be.

The structure of colloidal crystals on a curved surface can be observed using a Scanning Electron Microscope (SEM) by scanning the top view of the mono-dispersed particles microscopically. A HITACHI S-4800 SEM system is used herein. An SEM viewing sample is prepared by placing a piece of substrate with colloidal crystals on a conductive adhesive. The viewing sample is photographed after depositing a film of platinum several nanometers thick thereto.

### EXAMPLES

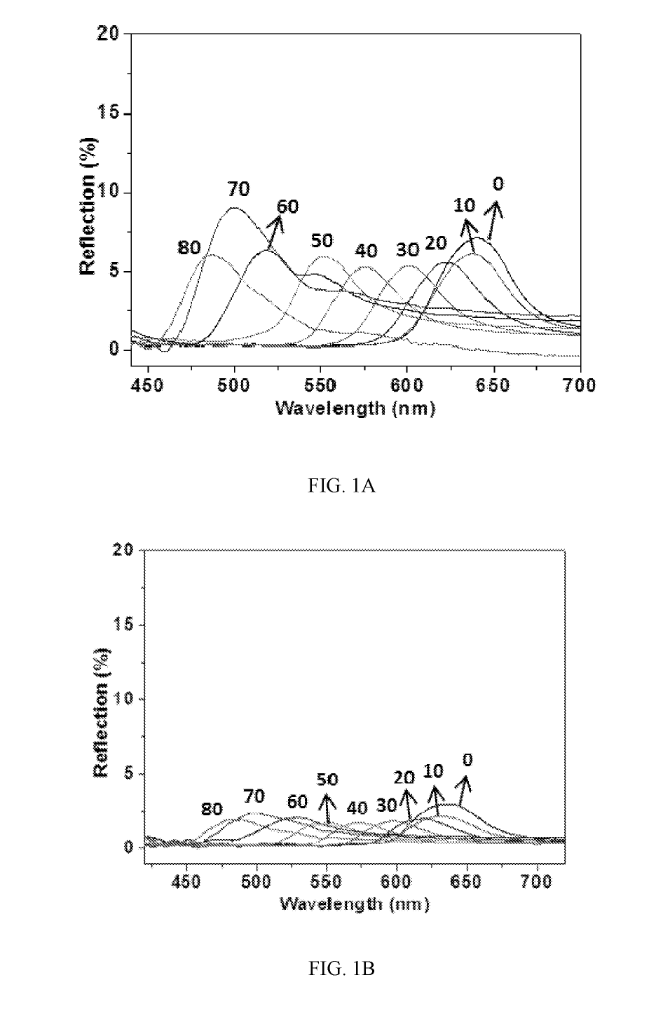

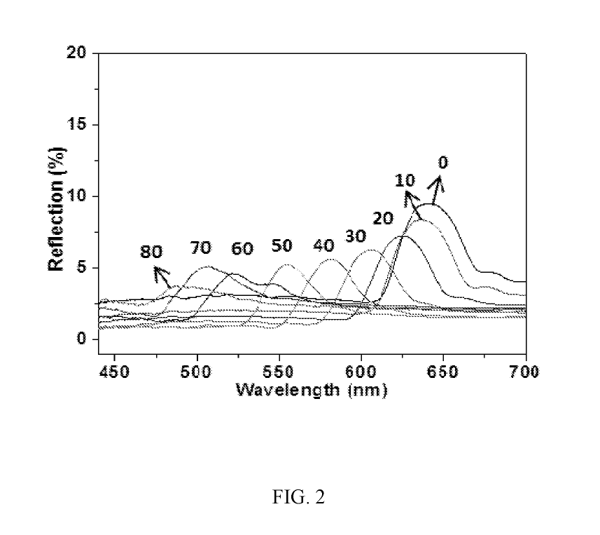

Table 2 below shows the reflectance spectrum for three examples—comparative examples 1 and 2 belonging to the prior art, and inventive example 1. Comparative example 1 illustrates the scenario when mono-dispersed polymer particles (formed of polystyrene-methyl methacrylate acrylic acid with a particle size of 273 nm) are applied to a flat aluminium surface (according to the BASF method). Here, the full range of visible colors can be seen as the reflection peak wavelength of light reflected from the colloidal crystals changes from 640 nm to 480 nm. The reflection intensity for each color is approximately equal, with a relatively high color intensity and a relatively small reflection peak width at half height. However, for a person to be able to see the different colors of the spectrum, the viewing angle would need to be changed considerably (more so than would happen naturally as a consumer moves past a shelf where packaging may be displayed). Furthermore, articles discussed in the present invention are typically expected to have some curvature, thus having a flat surface would not meet the needs of the present invention. Where the same mono-dispersed polymer particles are applied to a flat surface that is subsequently bent, as in comparative example 2, it can be seen that the different colors are not cleanly shown and that the overall reflectance level is very low. Although in this example, the reflection peak wavelength still changes from 640 nm to 480 nm, the overall reflection intensity is very low and the peak width at half height for each color is large. Thus, it can be expected that although all colors of the visible spectrum will be present, they will not be clearly seen (i.e. they will likely be blurred).

| | | Comparative | Comparative |
|---|---|---|---|
| | Inventive | Example 1 | Example 2 |
| | Sample 1 | (graph of Re- | (graph of Re- |
| | (graph of Reflec- | flectance Spec- | flectance Spec- |
| | tance Spectrum | trum shown as | trum shown as |
| | shown as FIG. 2) | FIG. 1A) | FIG. 1B) |
| Peak width | 45 nm in average | 53 nm in average | 60 nm in average |
| at half | | | |
| height | | | |
| Reflection | 6.2% in average | 6.3% in average | 2.1% in average |
| Intensity | | | |

Table 3 shows different embodiments according to the present invention, illustrating the different reflectance spectrums obtained with dispersion of different mono-dispersed particle sizes (on the same form of glass bottle with curvature of 0.48 cm⁻¹). From this it can be seen how different iridescent colors are obtained starting with a different particle size.

| | Angle-dependent reflec- | |
|---|---|---|
| | tance spectrum (Inven- | |
| | tive Samples 2 to 5, | |
| Particle | corresponding to | |
| size (nm) | FIGS. 3A-D) | Iridescent color effect |
| 187 | FIG. 3A | Multiple colours of blue and purple |
| | | can be seen at the same time when |
| | | viewing the bottle perpendicularly. |
| 215 | FIG. 3B | Multiple colours of green, cyan, |
| | | blue and purple can be seen at the |
| | | same time when viewing the bottle |
| | | perpendicularly. |
| 272 | FIG. 3C | All visible colours of the rainbow |
| | | (red, orange, yellow, green, cyan, |
| | | blue, purple) can be seen at the |
| | | same time when viewing the bottle |
| | | perpendicularly. |
| 302 | FIG. 3D | Multiple colours of red, orange, |
| | | yellow and green can be seen at the |
| | | same time when viewing the bottle |
| | | perpendicularly. |

### Examples/Combinations:

A. A method of decorating an article having an iridescent visual effect, the method comprising depositing a plurality of mono-dispersed particles onto a curved surface of the article, each particle having a size of from about 150 nm to about 360 nm with a polydispersity index

(PDI) of below 0.2, to form a layer of regularly-ordered colloidal crystals on a surface having a curvature of at least 0.002 cm-1.
B. A method according to paragraph A, wherein the plurality of mono-dispersed particles have a size of from about 258 nm to 325 nm.
C. A method according to paragraph A, wherein the colloidal crystals have a reflection main peak of from 300 nm to 900 nm.
D. A method according to paragraph A, wherein the colloidal crystals have a reflection main peak of from 630 nm to 780 nm.
E. A method according to paragraph A, wherein the surface of the article has a curvature of from 0.002 cm-1 to 2.0 cm-1.
F. A method according to paragraph A, wherein the layer of colloidal crystals has a thickness of from 1 μm to 1000 μm.
G. A method according to paragraph A, wherein the plurality of mono-dispersed particles are selected from a group consisting of mono-dispersed polymer particles and mono-dispersed inorganic particles, and a combination thereof.

H. A method according to paragraph G, wherein the mono-dispersed polymer particles are selected from the group consisting from the group consisting of polymethyl methacrylate, polyethyl metharylate, poly(n-butyl methacrylate), polystyrene, poly(chloro-styrene), poly(alpha-methyl-styrene), polystyrene-methyl methacrylate, polyalkylated acrylate, polyhydroxyl acrylate, polyamino acrylate, polycyanoacrylate, polyfluorinated acrylate, polyacrylic acid, polymethylacrylic acid, poly),ethyl methacrylate-ethyl acrylate-acrylic acid), poly(styrene-methyl methacrylate-acrylic acid), polylactide (PLA), polyurethane derivatives thereof, salts thereof, and a combination thereof.
I. A method according to paragraph G, wherein the mono-dispersed inorganic particles are selected from the group consisting of silica, titanium dioxide, zirconia, calcium carbonate, talc, and derivatives and combinations thereof.
J. A method according to paragraph A, wherein the article surface material is selected from the group consisting of glass, metal, ceramic, polymer, paper, fiber, wood, bamboo, and derivatives and combinations thereof.
K. An article with surface decoration, comprising:
   a) a surface with curvature of at least 0.002 cm⁻¹
   b) a layer of regularly-ordered colloidal crystals having a thickness of 1 μm to 1000 μm deposited on the surface, the colloidal crystals having a reflection peak wavelength of from 300 nm to 900 nm.
L. An article according to paragraph K, wherein the colloidal crystals have a peak width of reflectance of less than 200 nm.
M. An article according to paragraph K, wherein the article surface material is selected from the group consisting of glass, metal, ceramic, polymer, paper, fiber, wood, bamboo, derivatives thereof, and a combination thereof.
N. An article according to paragraph K, wherein the colloidal crystals provide iridescent reflection of colors.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of decorating an article having an iridescent visual effect, the method comprising depositing a plurality of mono-dispersed particles onto a curved surface of the article, each particle having a size of from about 150 nm to about 360 nm with a polydispersity index (PDI) of below 0.2, to form a layer of regularly-ordered colloidal crystals on a surface having a curvature of at least 0.002 cm⁻¹.

2. A method as claimed in claim 1, wherein the plurality of mono-dispersed particles have a size of from about 258 nm to 325 nm.

3. A method as claimed in claim 1, wherein the colloidal crystals have a reflection main peak of from 300 nm to 900 nm.

4. A method as claimed in claim 1, wherein the colloidal crystals have a reflection main peak of from 630 nm to 780 nm.

5. A method as claimed in claim 1, wherein the surface of the article has a curvature of from 0.002 cm⁻¹ to 2 cm⁻¹.

6. A method as claimed in claim 1, wherein the layer of colloidal crystals has a thickness of from 1 μm to 1000 μm.

7. A method as claimed in claim 1, wherein the plurality of mono-dispersed particles are selected from a group consisting of mono-dispersed polymer particles and mono-dispersed inorganic particles, and a combination thereof.

8. A method as claimed in claim 7, wherein the mono-dispersed polymer particles are selected from the group consisting from the group consisting of polymethyl methacrylate, polyethyl metharylate, poly(n-butyl methacrylate), polystyrene, poly(chloro-styrene), poly(alpha-methyl-styrene), polystyrene-methyl methacrylate, polyalkylated acrylate, polyhydroxyl acrylate, polyamino acrylate, polycyanoacrylate, polyfluorinated acrylate, poly acrylic acid, polymethylacrylic acid, poly),ethyl methacrylate-ethyl acrylate-acrylic acid), poly(styrene-methyl methacrylate-acrylic acid), polylactide (PLA), polyurethane derivatives thereof, salts thereof, and a combination thereof.

9. A method as claimed in claim 7, wherein the mono-dispersed inorganic particles are selected from the group consisting of silica, titanium dioxide, zirconia, calcium carbonate, talc, and derivatives and combinations thereof.

10. A method as claimed in claim 1, wherein the article surface material is selected from the group consisting of glass, metal, ceramic, polymer, paper, fiber, wood, bamboo, and derivatives and combinations thereof.

11. An article with surface decoration, comprising:
a) a surface with curvature of at least 0.002 cm⁻¹;
b) a layer of regularly-ordered colloidal crystals having a thickness of 1 μm to 1000 μm deposited on the surface, the colloidal crystals having a reflection peak wavelength of from 380 nm to 900 nm.

12. An article as claimed in claim 11, wherein the colloidal crystals have a peak width of reflectance of less than 200 nm.

13. An article as claimed in claim 11, wherein the article surface material is selected from the group consisting of glass, metal, ceramic, polymer, paper, fiber, wood, bamboo, derivatives thereof, and a combination thereof.

14. An article as claimed in claim 11, wherein the colloidal crystals provide iridescent reflection of colors.
